(19) United States
(12) Patent Application Publication
(10) Pub. No.: US 2026/0237828 A1
(43) Pub. Date: Aug. 13, 2026

(54) BATTERY CLUSTER AND ENERGY STORAGE SYSTEM

(71) Applicant: Sungrow Power Supply Co., Ltd., Hefei (CN)

(72) Inventors: Puyun Dong, Hefei (CN); Jinguo Su, Hefei (CN); Meng Zhou, Hefei (CN)

(73) Assignee: Sungrow Power Supply Co., Ltd., Hefei (CN)

(21) Appl. No.: 19/154,950

(22) PCT Filed: Apr. 25, 2023
(86) PCT No.: PCT/CN2023/090527

§ 371 Date: Aug. 8, 2025

(30) Foreign Application Priority Data
Mar. 20, 2023 (CN) 202320572848.6

(51) Int. Cl. H01M 50/298; H01M 10/613; H01M 10/6568; H01M 50/264

(52) U.S. Cl. CPC H01M 50/298; H01M 10/613; H01M 10/6568; H01M 50/264

(57) ABSTRACT

A battery cluster and an energy storage system are provided. The battery cluster includes a fixing device, at least two battery packs, and at least one electric cable for connecting the at least two battery packs in series. The fixing device is provided with a mounting position for the battery pack and a fixing position for the electric cable, the electric cable is fixed at the fixing position; and the battery pack is fixed at the mounting position. The cable and the fixing apparatus can be package together for transportation.

This application is a national stage filing under 35 U.S.C. § 371 of International Patent Application Serial No. PCT/CN 2023/090527, filed Apr. 25, 2023, which claims the priority to Chinese Patent Application No. 202320572848.6, titled “BATTERY CLUSTER AND ENERGY STORAGE SYSTEM”, filed on Mar. 20, 2023 with the China National Intellectual Property Administration. The contents of these applications are incorporated herein by reference in their entirety.

### FIELD The present application relates to the technical field of energy storage, and in particular to a battery cluster and an energy storage system.

### BACKGROUND

In recent years, with the gradual increase in demand for industrial and commercial energy storage, industrial and commercial energy storage products have experienced rapid development, and connection requirements within energy storage systems have also been continuously increased. In existing energy storage systems, during transportation, electric cables for series connection in a battery cluster are transported after packaging and then installed on site at the customer's location. However, this transportation method results in relatively high transportation costs.

Therefore, a technical problem to be addressed by those skilled in the art is to reduce the transportation costs of the energy storage systems.

### SUMMARY

A battery cluster and an energy storage system are provided according to the present application, so as to reduce transportation costs of the energy storage system.

To achieve the above object, the following technical solutions are provided according to the present application.

A battery cluster is provided according to a first aspect of the present application, including a fixing device, at least one battery pack and an electric cable.

The fixing device is provided with a mounting position for each of the at least one battery pack and a fixing position for the electric cable.

The electric cable is fixed at the fixing position.

Each of the at least one battery pack is fixed at the corresponding mounting position.

An energy storage system is further provided according to a second aspect of the present application, including at least one battery cluster according to any one of the above solutions.

In the battery cluster according to the present application, by providing the mounting position for the battery pack in the fixing device, the fixing of the battery pack can be achieved. Moreover, the fixing position for the electric cable is also provided in the fixing device, and the electric cable is fixed at corresponding fixing position. With the above arrangement, the electric cable and the fixing device can be packaged and transported together when the battery cluster is transported, thus reducing the transportation cost.

### BRIEF DESCRIPTION OF THE DRAWINGS

For more clearly illustrating embodiments of the present application or the technical solutions in the related art, drawings referred to describe the embodiments or the related art will be briefly described hereinafter. Apparently, the drawings in the following description are only some examples of the present application, and for those skilled in the art, other drawings may be obtained based on these drawings without any creative efforts.

FIG. 1 is a front view of a battery cluster according to an embodiment of the present application;

FIG. 2 is a perspective view of the battery cluster according to the embodiment of the present application;

FIG. 3 is another front view of a battery cluster according to an embodiment of the present application;

FIG. 4 is yet another front view of a battery cluster according to an embodiment of the present application;

FIG. 5 is a schematic structural view of an energy storage system according to an embodiment of the present application; and

FIG. 6 is another schematic structural view of an energy storage system according to an embodiment of the present application.

### DETAILED DESCRIPTION OF THE EMBODIMENTS

Technical solutions according to the embodiments of the present application will be described clearly and completely as follows in conjunction with the accompany drawings in the embodiments of the present application. It is obvious that the described embodiments are only a part of the embodiments according to the present application, rather than all of the embodiments. All the other embodiments obtained by those skilled in the art based on the embodiments in the present application without any creative work belong to the scope of protection of the present application.

In this application, the terms “include”, “comprise” or any other variations are intended to cover non-exclusive “include”, thus a process, a method, an object or a device including a series of factors not only include the listed factors, but also include other factors not explicitly listed, or also include inherent factors of the process, the method, the object or the device. Without more limitations, a factor defined by a sentence “include one . . . ” does not exclude a case that there is another same factor in the process, the method, the object or the device including the described factor.

A battery cluster is provided according to the present application, to reduce transportation costs of an energy storage system.

The battery cluster provided in this embodiment includes a fixing device, at least one battery pack, and an electric cable. The fixing device is provided with a mounting position for each of the at least one battery pack and a fixing position for the electric cable. The electric cable is fixed at the fixing position, and each of the at least one battery pack is fixed at the corresponding mounting position.

In practical applications, when the battery cluster includes at least two battery packs, the electric cables are used to achieve series connection between each two adjacent battery packs. The battery packs in the battery cluster are arranged in an up-down direction within the fixing device in an alternative manner that positive and negative poles of each battery pack and positive and negative poles of the adjacent battery pack are oppositely provided in a left-right direction. Adjacent electric cables are arranged at the corresponding fixing positions, where the corresponding fixing positions are alternatively provided at left and right in sequence.

It should be noted that a cabinet frame and side fixing plates can be used as the fixing device, with the mounting positions being provided in the cabinet frame and the fixing positions being provided in the side fixing plates. Alternatively, only the cabinet frame serves as the fixing device, with both the mounting positions and the fixing positions being provided in the cabinet frame.

In practical applications, the fixing position for the electric cable includes a wire fixing position. A wire of the electric cable is fixed at the wire fixing position by a cable tie or a quick clamp. The wire fixing position is provided at the fixing device located between power interfaces of two adjacent battery packs. A distance from the wire fixing position to any end of the electric cable is less than a distance from the wire fixing position to any power interface that is incorrect for the any end of the electric cable. In practical applications, the fixing position for the electric cable is not limited to the above description and can be determined depending on the specific application environment, which are within the protection scope of the present application.

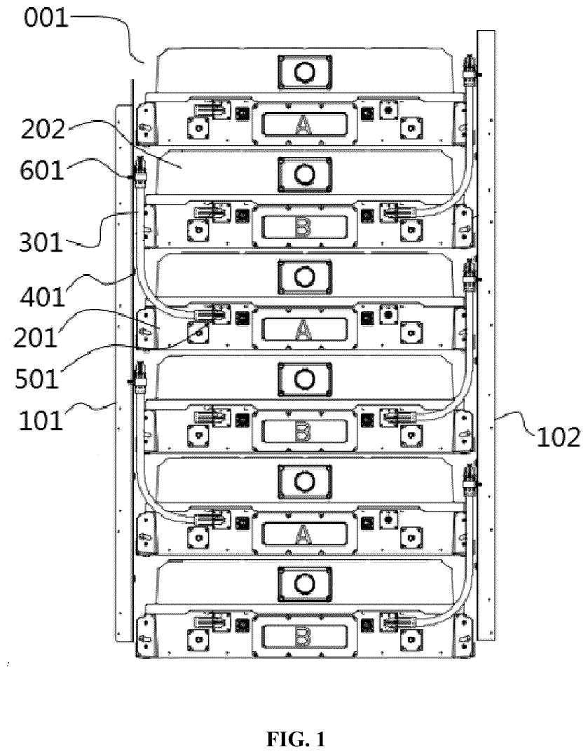

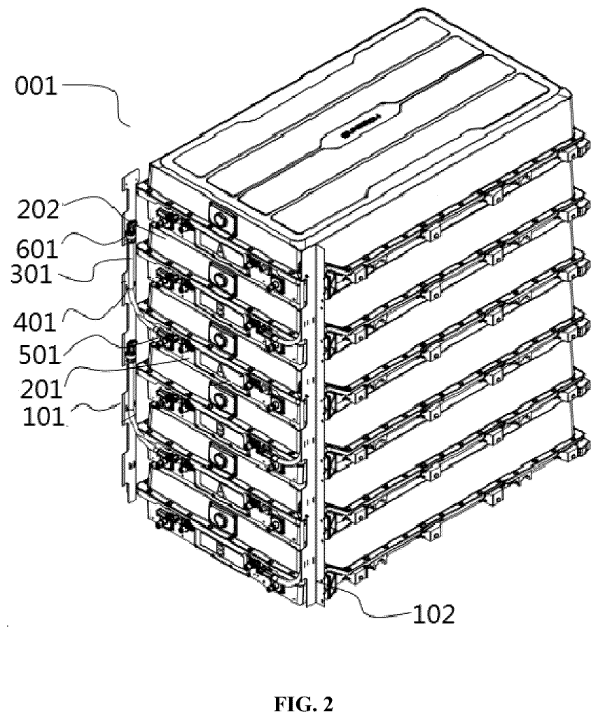

When the fixing device includes a cabinet frame and side fixing plates, as shown in FIGS. 1 and 2, which are front view and perspective view of the battery cluster 001 respectively. The battery cluster 001 includes a cabinet frame (an enclosure as shown in the figures), side fixing plates (101 and 102 in the figures), at least one battery pack (201 and 202 in the figures), and electric cables (301 in the figure). The electric cables are arranged at the corresponding fixing positions, where the fixing positions are alternatively provided at left and right in sequence. The positive and negative poles of each battery pack 201 and the positive and negative poles of the adjacent battery pack 202 are oppositely provided in the left-right direction, and the adjacent battery packs 201 and 202 are alternatively arranged in an up-down direction in the cabinet frame between the side fixing plate 101 and the side fixing plate 102. A wire fixing position 401 is provided on a portion of the side fixing plate 101 between power interfaces of the battery packs 201 and 202, and the wire of the electric cable 301 is fixed at the wire fixing position 401 by a cable tie, to connect the corresponding poles of the battery packs 201 and 202. A distance from the wire fixing position 401 to either of both ends of the electric cable 301 is less than a distance from the wire fixing position 401 to an incorrect power interface for the electric cable 301.

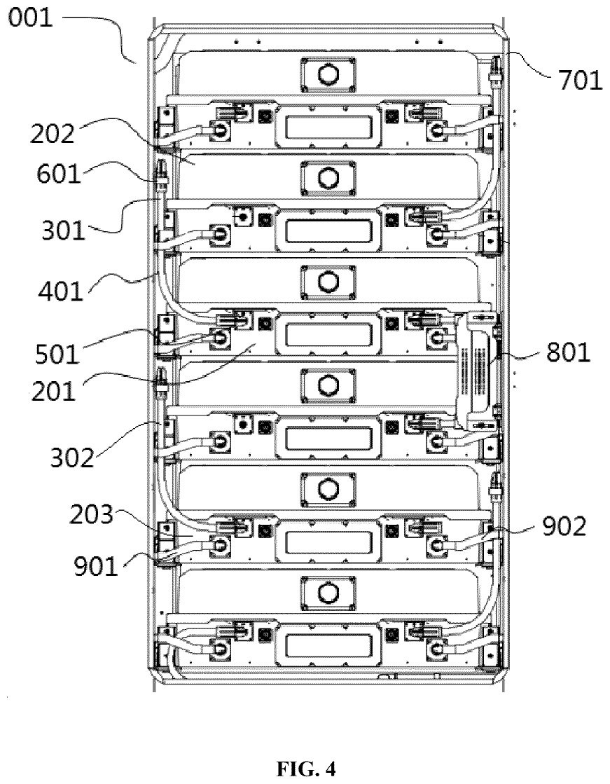

When the fixing device only includes a cabinet frame 701, as shown in FIG. 4, the battery packs 201 and 202 are alternatively arranged in an up-down direction in the cabinet frame 701. The wire fixing position 401 is provided on a portion of the cabinet frame 701 between the power interfaces of the battery packs 201 and 202, and the wire of the electric cable 301 is fixed at the wire fixing position 401 on the cabinet frame 701 by a cable tie, to connect the corresponding poles of the battery packs 201 and 202. A distance from the wire fixing position 401 to either of both ends of the electric cable 301 is less than a distance from the wire fixing position 401 to an incorrect power interface for the electric cable 301.

In the battery cluster 001 according to this embodiment, by providing mounting positions for the battery packs in the fixing device, the fixing of the battery packs can be achieved. Moreover, the fixing positions for the electric cables are also provided in the fixing device, and the electric cables are fixed at the corresponding fixing positions. This allows the electric cables to be packaged and transported together with the fixing device when the battery cluster 001 is transported, realizing integrated transportation of the battery cluster 001 with the electric cables and reducing the transportation cost of the electric cables. The wire of the electric cables are fixed at the wire fixing positions by using cable ties or quick-release clamps to prevent movement or loss of the electric cables during transportation. Each of the wire fixing positions is provided to make the distance from to either of both ends of the corresponding electric cable to be less than the distance from the wire fixing position to the power interface that is incorrect for the end of the electric cable, so as to prevent incorrect connections of the ends of the electric cables, which improves the safety and reliability of the battery cluster 001, and thereby achieving effective fool-proofing.

For the battery cluster in the related art, both ends of the electric cables need to be installed on site at the customer's location, involving a large amount of installation work and a high risk of incorrect connections, which may lead to short circuits between the battery packs and thereby causing damage to the battery cluster.

Therefore, on the basis of the previous embodiment, in this embodiment, the battery cluster 001 is configured such that before installation, one end of each electric cable is in an electrically connected state, while the other end is in a non-electrically connected state.

More preferably, the fixing position for each of the electric cables includes a first end fixing position. Before installation, the end of each of the electric cables that is in a non-electrically connected state is fixed at the corresponding first end fixing position through a quick-release clamp or cable tie.

Specifically, the battery cluster 001 is shown in FIGS. 1 and 2. Before installing the battery cluster, one end of the electric cable 301 is electrically connected to the power interface 501 in the battery pack 201, while the other end of the electric cable is in a non-electrically connected state. The end in the non-electrically connected state is fixed at the first end fixing position 601 on the side fixing plate 101 through a quick-release clamp. In practical applications, as shown in FIG. 4, the end of the electric cable 301 in the non-electrically connected state may also be fixed at the first end fixing position 601 on the cabinet frame 701 through a quick-release clamp.

In the battery cluster 001 according to this embodiment, one end of the electric cable being in the electrically connected state while the other end being in the non-electrically connected state before installing the battery cluster, such that only the other end of the electric cable needs to be installed on site at the customer's location, which ensures that there is only one installation method without altering the structural design of the battery pack, preventing incorrect connections, improving the safety and reliability of the battery cluster 001, and achieving effective fool-proofing. In addition, it reduces the installation workload by half, shortens the installation time, and provides a better user experience. Moreover, by using the quick-release clamp or cable tie to fix the non-SUBSTITUTE electrically connected end of the electric cable to the fixing device, the electric cable is prevented from being moved or lost during transportation.

In one embodiment, the fixing position for each of the electric cables in the battery cluster 001 includes a second end fixing position and a third end fixing position. The second end fixing position is provided within a range of a side projection of one of the battery packs corresponding to the second end fixing position on the fixing device, and the third end fixing position is provided within a range of a side projection of another one of the battery packs corresponding to the third end fixing position on the fixing device, where each of the side projections is the side projection closer to the corresponding power interface. Both ends of the electric cable are fixed at the second end fixing position and the third end fixing position through quick-release clamps respectively.

In practical applications, ports at the two ends of the electric cable are of different types and the ports are used to connect to the corresponding power interfaces in adjacent battery packs, so as to prevent incorrect connections. Additionally, the port of each of the electric cables connected to the negative power interface of the battery pack may be black, and the port connected to the positive power interface of the battery pack may be orange. In practical applications, the arrangement of the cables is not limited to this, it depends on the specific application environment instead, which falls within the protection scope of the present application.

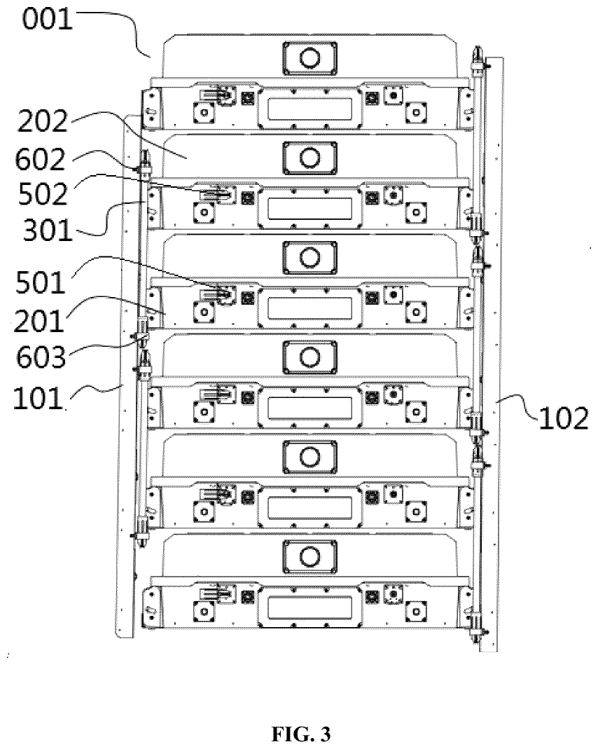

In practical applications, the battery cluster 001 may be as shown in FIG. 3, the second end fixing position 602 is provided within a range of a side projection of the battery pack 202 on the side fixing plate 101, where the side projection is the one which is closer to power interface 502. The third end fixing position 603 is provided within a range of a side projection of the battery pack 201 on the side fixing plate 101, where the side projection is the one which is closer to power interface 501. One end of the electric cable 301 is fixed at the second end fixing position 602 through a quick-release clamp, while the other end is fixed at the third end fixing position 603 through another quick-release clamp.

In the battery cluster 001 according to this embodiment, two ends of each of the electric cable are fixed at the second end fixing position and the third end fixing position, respectively, and the second end fixing position and the third end fixing position are provided beside the power interfaces of the corresponding battery packs, so as to prevent incorrect connections of the electric cables, thereby improving the safety and reliability of the battery cluster 001 and achieving effective fool-proofing.

On the basis of the above embodiment, as shown in FIG. 4, the battery cluster 001 further includes a fuse protection structure 801, which is arranged in a line connected between the battery packs of the battery cluster 001 in a series manner.

In practical applications, when the current in the series branch exceeds a preset value, the overload current passing through the fuse element in the fuse protection structure 801 generates heat, causing the fuse element to melt and thus breaking the series circuit to prevent damage to the battery packs due to current overload.

In the battery cluster 001 according to this embodiment, the fuse protection structure 801 is provided in the series branch of the battery cluster 001, which prevents damage to the battery packs due to current overload, protecting the series branch and thereby improving the safety and reliability of the battery cluster 001.

On the basis of the above embodiment, preferably, each of the battery packs in the battery cluster 001 is connected to an inlet pipe and an outlet pipe. The inlet pipe is connected to a water inlet of the battery pack, and the outlet pipe is connected to a water outlet of the battery pack.

As shown in FIG. 4, the inlet pipe 901 in the battery cluster 001 is connected to the water inlet of battery pack 203, and the outlet pipe 902 is connected to the water outlet of battery pack 203. Moreover, the inlet pipe 901, the outlet pipe 902, and the electric cable 302 in the battery cluster 001 are spaced apart from one another. The arrangement in practical application, however, is not limited to the above, it depends on the specific application environment, which falls within the protection scope of the present application.

In the battery cluster 001 according to this embodiment, the inlet pipe is connected to the water inlet of the battery pack and the outlet pipe is connected to the water outlet of the battery pack, so that there's no need to install the inlet and outlet pipes on site at the customer's location, which reduces installation workload, shortens installation time, and thereby providing a better user experience.

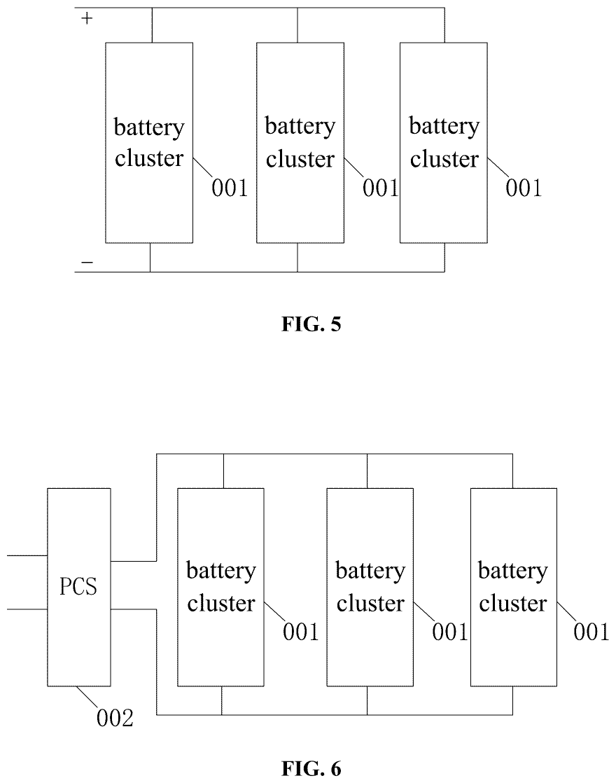

An energy storage system is further provided according to another embodiment of the present application, which includes at least one battery cluster 001 as described in any one of the above embodiments. As shown in FIG. 5 (the case where only three battery clusters 001 being included is taken as an example), when there are multiple battery clusters 001, the battery clusters 001 are connected in parallel.

Optionally, the energy storage system may further include a PCS (Power Conversion System) 002 as shown in FIG. 6. A direct current side of the PCS 002 is connected to the battery cluster 001, and an alternating current side thereof is connected to the power grid through a transformer.

In the energy storage system according to this embodiment, at least one battery cluster 001 as described in any one of the above embodiments is employed to form the energy storage system, which facilitates on-site installation for customers and saves transportation costs for the energy storage system. The PCS 002 is also employed to achieve bidirectional power conversion for charging and discharging of each of the battery clusters 001.

The same or similar parts among the embodiments in this specification may be referred to each other, and each of the embodiments is mainly focused on describing its differences from other embodiments. In particular, the system or system embodiment is basically similar to the method embodiment, and therefore is described relatively briefly. For relevant details, reference may be made to the corresponding description of the method embodiment. The system and system embodiments described above are only illustrative, in which the units described as separate components may or may not be physically separated, and the components shown as units may or may not be physical units, that is, may be located in one place, or distributed over multiple network elements. Some or all of the modules may be selected as needed to achieve the objective of the solution according to the embodiments. Those skilled in the art can understand and implement the solution without any creative effort.

Those skilled in the art may further realize that the units and algorithm steps of each example described in conjunction with the embodiments disclosed herein can be implemented by electronic hardware, computer software, or a combination of both. In order to clearly illustrate the interchangeability of hardware and software, the modules and steps of each example have been described in general terms of functionality in the above description. Whether these functions are performed in hardware or software depends on the specific application and design constraints of the technical solution. Those skilled in the art may use different methods to implement the described functions for each specific application, but such implementation should not be regarded as exceeding the scope of the present application.

Based on the above description of the disclosed embodiments, the features described in the various embodiments in this specification may be substituted or combined with each other to enable those skilled in the art to implement or use the present application. It is obvious for those skilled in the art to make multiple modifications to these embodiments. The general principle defined herein may be applied to other embodiments without departing from the spirit or scope of the present application. Therefore, the present application shall not be limited to the embodiments described herein, but should be defined by the broadest scope consistent with the principle and novel features disclosed herein.

1. A battery cluster, comprising a fixing device, at least two battery packs, and an electric cable configured for connecting the at least two battery packs in series; wherein
the fixing device is provided with a mounting position for each of the at least two battery packs and a fixing position for each of the at least one electric cable;
each of the at least one electric cable is fixed at the corresponding fixing position; and
each of the at least two battery packs is fixed at the corresponding mounting position.

2. (canceled)

3. The battery cluster according to claim 1, wherein the fixing position for the electric cable comprises a wire fixing position, wherein
a wire of the electric cable is fixed at the wire fixing position by a cable tie or a quick-release clamp;
the wire fixing position is provided at the fixing device located between power interfaces of two adjacent battery packs of the at least two battery packs; and
a distance from the wire fixing position to any end of the electric cable is less than a distance from the wire fixing position to any power interface that is incorrect for the any end of the electric cable.

4. The battery cluster according to claim 3, wherein one end of the electric cable is in an electrically connected state, while the other end of the electric cable is in a non-electrically connected state before installing the battery cluster.

5. The battery cluster according to claim 4, wherein the fixing position for the electric cable further comprises a first end fixing position, wherein
the other end of the electric cable that is in the non-electrically connected state is fixed at the first end fixing position by a quick-release clamp or a cable tie before installing the battery cluster.

6. The battery cluster according to claim 1, wherein the fixing position for the electric cable comprises a second end fixing position and a third end fixing position, wherein
the second end fixing position is provided within a range of a side projection of one of the battery packs corresponding to the second end fixing position on the fixing device, and the third end fixing position is provided within a range of a side projection of another one of the battery packs corresponding to the third end fixing position on the fixing device; and
both ends of the electric cable are fixed at the second end fixing position and the third end fixing position by quick-release clamps respectively.

7. The battery cluster according to claim 1, wherein
the battery packs are arranged in an up-down direction within the fixing device in an alternative manner that positive and negative poles of each of the battery packs and positive and negative poles of the adjacent battery pack are oppositely provided in a left-right direction; and
the adjacent electric cables are arranged at the corresponding fixing positions, where the corresponding fixing positions are alternatively provided at left and right sides of the at least two battery packs in sequence.

8. The battery cluster according to claim 1, wherein the fixing device comprises a cabinet frame, and the mounting position and the fixing position are provided in the cabinet frame.

9. The battery cluster according to claim wherein the fixing device comprises a cabinet frame and side fixing plates, and wherein the mounting position is provided in the cabinet frame and the fixing position is provided in the side fixing plates.

10. The battery cluster according to claim 1, further comprising a fuse protection structure, wherein
the fuse protection structure is arranged in a line connected between the battery packs of the battery cluster in a series manner.

11. The battery cluster according to claim 1, comprising an inlet pipe and an outlet pipe, wherein each of the at least two battery packs comprises a water inlet connected to the inlet pipe and a water outlet connected to the outlet pipe, and wherein
the inlet pipe, the outlet pipe, and the at least one electric cable are spaced apart from one another.

12. (canceled)

13. An energy storage system, comprising at least one battery cluster according to claim 1.

14. An energy storage system, comprising at least one battery cluster according to claim 3.

15. An energy storage system, comprising at least one battery cluster according to claim 4.

16. An energy storage system, comprising at least one battery cluster according to claim 5.

17. An energy storage system, comprising at least one battery cluster according to claim 6.

18. An energy storage system, comprising at least one battery cluster according to claim 7.
